(19) United States
(12) Patent Application Publication
(10) Pub. No.: US 2007/0015496 A1
(43) Pub. Date: Jan. 18, 2007

(54) Method and apparatus for rejecting call reception in a mobile communication terminal

(75) Inventors: Yeong-Seong Yoon, Seoul (KR); Hee-Deog Kim, Seongnam-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/487,197

(22) Filed: Jul. 14, 2006

(30) Foreign Application Priority Data
Jul. 14, 2005 (KR) 2005-0063612

(51) Int. Cl. H04M 3/42

(52) U.S. Cl. 455/417

(57) ABSTRACT

The present invention relates to a method and apparatus for rejecting call reception in a mobile communication terminal. If the call reception rejecting key is inputted, a CID included in an incoming call is identified. If the CID is identified, it is checked to determine whether the call reception rejecting message is inputted. If the call reception rejecting message is inputted, the call reception rejecting message is transmitted to the caller using identified CID.

### PRIORITY

This application claims priority under 35 U.S.C. § 119 to an application entitled “Method For Rejecting Call Reception In A Mobile Communication Terminal” filed in the Korean Intellectual Property Office on Jul. 14, 2005 and assigned Serial No. 2005-63612, the contents of which are incorporated herein by reference.

### BACKGROUND OF THE INVENTION

1. Field of the Invention

The present invention relates to a method and an apparatus for rejecting call reception in a mobile communication terminal, and particularly to a method and an apparatus for transmitting a call reception rejecting message using a Caller IDentification (hereinafter referred to as CID) in the mobile communication terminal.

2. Description of the Related Art

Mobile communication terminals are widely used due to their convenient portability and mobility. Manufacturers develop more convenient mobile communication terminals in an effort to secure more users. For example, the mobile communication terminals provide various additional functions of a phone book, a game, a short message, an internet, an e-mail, a morning call, a MPEG Layer 3 or a digital camera. Also, the mobile communication terminals provide functions of etiquette mode and auto-answering mode to tolerate indiscreet use in public space such as a conference room, a subway station or a public bus.

In particular, the mobile communication terminals provide a function of rejecting call reception to reject an unwanted call.

FIG. 1 is a flowchart illustrating a procedure of rejecting an incoming call in a conventional mobile communication terminal.

Referring to FIG. 1, a MPU (Micro-Processor Unit) acts as a controller of the mobile communication terminal and checks whether an incoming call is received from another terminal in step 101. If the incoming call is not received, the MPU proceeds to step 111 to perform a present mode (e.g. waiting mode).

If the incoming call is received, the MPU proceeds to step 103 to display a message for notifying of an incoming call (e.g. You have a call from 011-000-1234) on a display unit, or to generate an alert sound or a tremor, thereby notifying a user of the incoming call.

Next, the MPU proceeds to step 105 to check whether the call reception rejecting key is inputted. If the call reception rejecting key is inputted, the MPU proceeds to step 107 to transmit an Out Going Message (OGM) to the caller which is an auto-answering message, stored in the mobile communication terminal.

If the call reception rejecting key is not inputted, the MPU proceeds to step 109 to perform general call communication mode. Herein, the general call communication mode means that the MPU connects a call if a TALK key is pressed. After this, the MPU ends this algorithm.

As described above, when call reception is rejected, the MPU transmits the OGM to the caller and notifies the caller that the mobile communication terminal can not receive the incoming call. However, when the caller received the OGM can not know the reason of call rejection and can not know the available time to call.

Thus, the method to notify the caller the reason of call rejection and the available time to connect an incoming call is needed.

### SUMMARY OF THE INVENTION

Accordingly, an object of the present invention is to provide a method of transmitting a call reception rejecting message including the reason of call rejection upon incoming call rejection in a mobile communication terminal.

Another object of the present invention is to provide a method of transmitting a call reception rejecting message including the available time to connect an incoming call upon incoming call rejection in a mobile communication terminal.

Another object of the present invention is to provide a method of transmitting a call reception rejecting message using a Caller IDentification (hereinafter referred to as CID) included in an incoming call upon incoming call rejection in a mobile communication terminal.

According to one aspect of the present invention for achieving the above objects, in the method of rejecting an incoming call in a mobile communication terminal, a call reception rejecting key is inputted when a reception call is received. If the call reception rejecting key is inputted, a CID included in the reception call is identified. If the CID is identified, a check is performed to determine whether the call reception rejecting message is inputted. If the call reception rejecting message is inputted, the call reception rejecting message is transmitted to the caller.

### BRIEF DESCRIPTION OF THE DRAWINGS

The above and other objects, features, and advantages of the present invention will become more apparent from the following detailed description when taken in conjunction with the accompanying drawings in which:

FIG. 1 is a flowchart illustrating a procedure of rejecting call reception in a conventional mobile communication terminal;

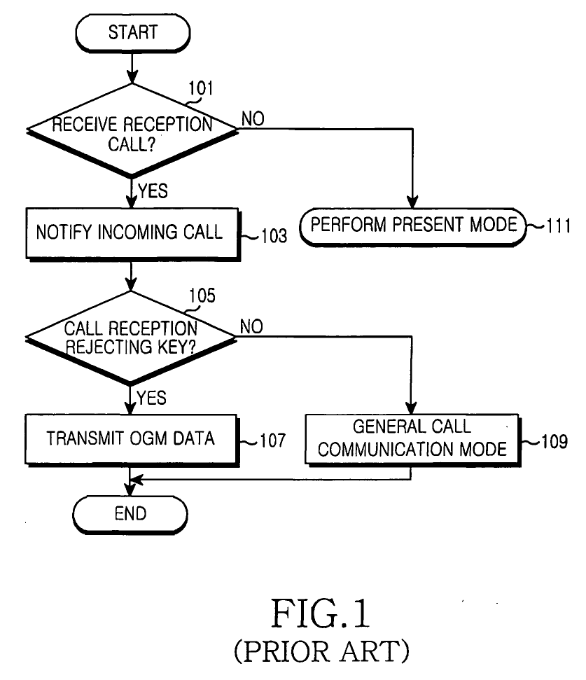

FIG. 2 is a block diagram of mobile communication terminal according to the present invention; and

FIG. 3 is a flowchart illustrating a procedure of rejecting call reception in a mobile communication terminal according to the present invention.

### DETAILED DESCRIPTION OF THE PREFERRED EMBODIMENTS

Preferred embodiments of the present invention will be described below with reference to the accompanying drawings. In the following description, well-known functions or constructions are not described in detail because they would obscure the present invention with unnecessary detail.

The present invention will be described with reference to a technology for transmitting a call reception rejecting message by using Caller IDentification (CID) included in a reception call when rejecting call reception in a mobile communication terminal.

The call reception rejecting message is a message such as a Short Message Service (SMS) message, an email, a Multimedia Message Service (MMS) message or an Enhanced Message Service (EMS) message.

Hereinafter, an SMS message type call reception rejecting message will be described.

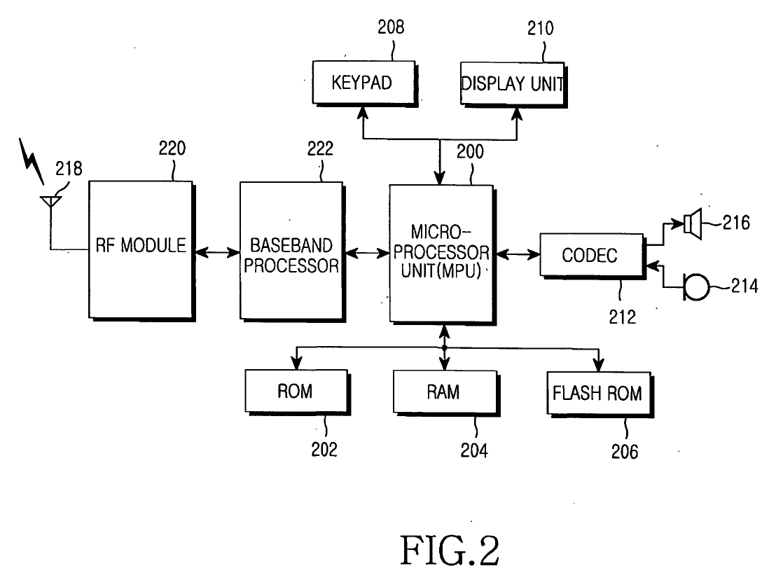

FIG. 2 illustrates a block diagram of a mobile communication terminal according to the present invention. The mobile communication terminal includes a cellular phone, a Personal Communication System (PCS), a Personal Data Assistant (PDA), International Mobile Telecommunication-2000 (IMT2000) and the like. Hereinafter, a general function configuration of the above examples will be described.

Referring to FIG. 2, a Micro-Processor Unit (MPU), acting as a controller, 200 controls an overall operation of the mobile communication terminal. For example, the MPU 200 is responsible for processing and controlling voice communication and data communication. In addition to the typical functions, the MPU 200 processes functions for transmitting a call reception rejecting message using a CID included in an incoming call when rejecting the incoming call. A detailed description of the typical processing and controlling operation of the MPU 200 is understood by those of skill in the art.

Read Only Memory (ROM) 202 stores a microcode of software for processing and controlling the MPU 200 and all reference data, in particular, for transmitting a call reception rejecting message using a CID included in a reception call. A Random Access Memory (RAM) 204, which is a working memory of the MPU, stores temporary data being generated while performing all software. A flash ROM 206 stores various updatable data to be kept, such as a phone book, an outgoing message or an incoming message.

A key pad 208 includes numeric keys of digits 0-9 and a plurality of function keys, such as a MENU key, a CANCEL (REMOVE) key, an ENTER key, a TALK key, an END key, an internet connection key and navigation keys (▴/▾/ [symbol] The key input data corresponding to a key pressed by the user is provided to the MPU 200. A display unit 210 displays status information, a number of characters, moving pictures and still pictures and the like. The display unit 210 may be a color LCD (Liquid Crystal Display).

A Coder-Decoder (CODEC) 212 connected to the MPU 200, a microphone 214, and a speaker 216 connected to the CODEC 212 are audio input/output blocks for use in telephone call and voice recording. The MPU 200 produces PCM (Pulse Code Modulation) data and the CODEC 212 converts the PCM data into analog audio signals. The analog audio signals are outputted through the speaker 216. Also, the CODEC 212 converts analog audio signals received through the microphone 214 into PCM data and provides the MPU 200 to the PCM data.

Radio Frequency (RF) unit 220 drops a frequency of an RF signal received through an antenna 218 and provides the RF signal to a baseband processor 222. Also, the RF unit 220 increases a frequency of a baseband signal provided from the baseband processor 222, transmits the baseband signals through the antenna 218. The baseband processor 222 processes the baseband signals which are transmitted/received between the RF unit 220 and the MPU 200. For example, for data transmission, the baseband processor 222 performs channel coding and spreading transmitting data. For data reception, the baseband processor 222 performs despreading and channel decoding for reception data.

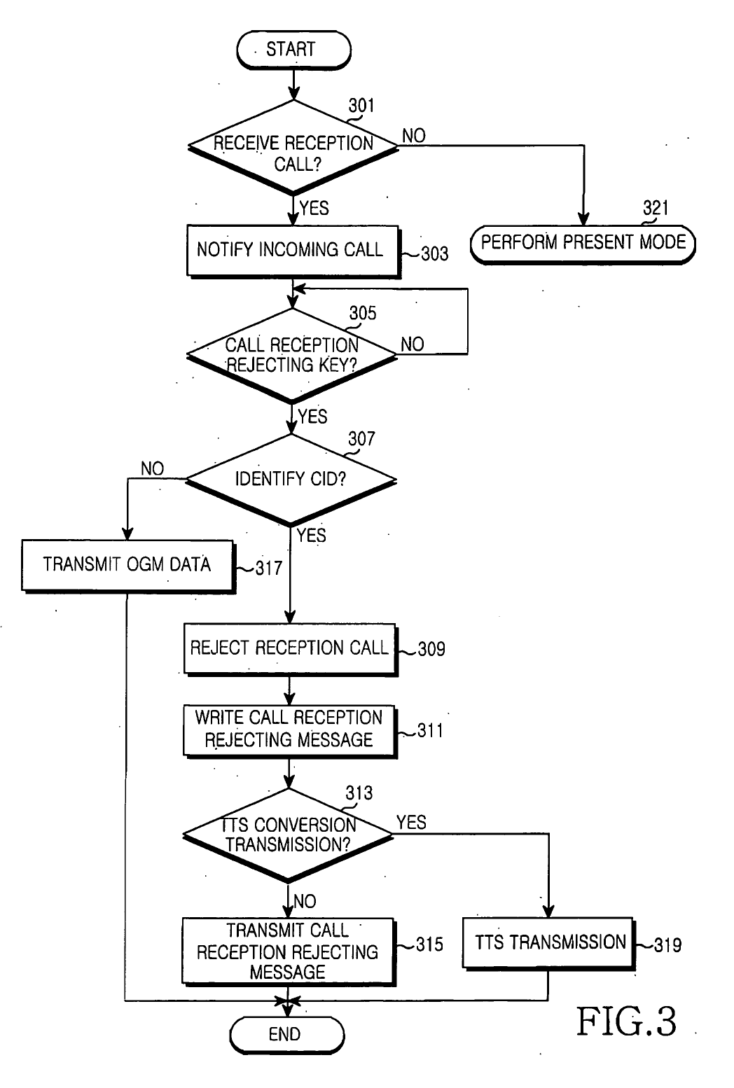

FIG. 3 is a flowchart illustrating a procedure of rejecting call reception in a mobile communication terminal according to the present invention.

Referring to FIG. 3, in step 301, the MPU, acting as the controller, 200 checks whether an incoming call is received. If the incoming call is not received, the MPU 200 proceeds to step 321 to perform the present mode (e.g. waiting mode).

If the incoming call is received, the MPU 200 proceeds to step 303 to display a message for notifying of an incoming call (e.g. You have a call from 011-000-1234) on the display unit 210. Generating an alert sound or a tremor may also be a method to notify a user of the incoming call.

Next, in step 305, the MPU checks whether a call reception rejecting key is inputted by a user's key manipulation. An “up” key on the side of the mobile communication terminal is a preferable call reception rejecting key.

If the call reception rejecting. key is inputted, the MPU 200 proceeds to step 307 to identify a CID included in an incoming call. If the incoming call does not include the CID and the MPU 200 cannot identify the CID, the MPU 200 proceeds to step 317 to transmit an Out Going Message, (OGM) which is an auto-answering message stored in the mobile communication terminal, to the caller.

Meanwhile, if the CID is identified, the MPU 200 proceeds to step 309 to reject or disconnect the incoming call. Next, the MPU 200 proceeds to step 311 to input a call reception rejecting message. Here, the call reception rejecting message may be inputted by user key manipulation or be selected among stored messages in the mobile communication terminal.

When the call reception rejecting message has been inputted or selected, the MPU 200 proceeds to step 313 to check if it performs a Text To Speech (hereinafter referred to as TTS) transmission of the call reception rejecting message. Here, the TTS conversion of the call reception rejecting message may be performed by a TTS module in the mobile communication terminal. The TTS conversion may alternatively be performed in a base station.

If the TTS transmission is not selected, the MPU 200 proceeds to step 315 to transmit the call reception rejecting message to the caller using the identified CID.

Meanwhile, if the TTS transmission is selected, the MPU 200 proceeds to step 319 to convert the call reception rejecting message to a voice message by the TTS conversion and transmit the voice message to the caller using the identified CID.

After this, the MPU 200 ends this algorithm.

As described above, in accordance with the present invention, a mobile communication terminal transmits a call reception rejecting message including the reason of call rejection or/and the available time to connect an incoming call upon incoming call rejection. Here, the mobile communication terminal transmits the call reception rejecting message to the caller using identified CID.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method of rejecting an incoming call in a mobile communication terminal, comprising:
initiating a call reception rejecting function;
identifying a caller identification included in the incoming call; and
transmitting a call reception rejecting message to a caller using the identified caller identification.

2. The method of claim 1, wherein the call reception rejecting message is inputted by a key manipulation or is selected from among stored messages in the mobile communication terminal.

3. The method of claim 1, wherein the call reception rejecting message is one of a short message service message, an email, a multimedia message system message and an enhanced message service message.

4. A method of rejecting an incoming call in a mobile communication terminal, comprising:
initiating a call reception rejecting function;
identifying a caller identification included in the incoming call;
inputting a text version call reception rejecting message;
performing a text to speech conversion of the call reception rejecting message; and
transmitting the converted call reception rejecting message to a caller using the caller identification.

5. The method of claim 4, wherein the call reception rejecting message is inputted by a key manipulation or is selected from among stored messages in the mobile communication terminal.

6. The method of claim 4, wherein the call reception rejecting message is one of a short message service message, an email, a multimedia message system message and an enhanced message service message.

7. A method of rejecting an incoming call in a mobile communication terminal, comprising:
initiating a call reception rejecting function;
identifying a caller identification included in the incoming call; and
transmitting an auto-answering message to a caller terminal if the caller identification is not identified.

8. A method of rejecting an incoming call in a mobile communication terminal, comprising:
checking whether a call reception rejecting key is inputted when the incoming call is received;
identifying a caller identification included in the incoming call if the call reception rejecting key is inputted;
checking whether a call reception rejecting message is inputted if the caller identification is identified; and
transmitting the call reception rejecting message by using the caller identification if the call reception rejecting message is inputted.

9. The method of claim 8, wherein the call reception rejecting message is inputted by a key manipulation or is selected from among stored messages in the mobile communication terminal.

10. The method of claim 8, wherein the call reception rejecting message is one of a short message service message, an email, a multimedia message system message and an enhanced message service message.

11. A method of rejecting an incoming call in a mobile communication terminal, comprising:
checking whether a call reception rejecting key is inputted when the incoming call is received;
identifying a caller identification included in the incoming call if the call reception rejecting key is inputted;
checking whether a text type call reception rejecting message is inputted if the caller identification is identified;
performing a text to speech conversion of the call reception rejecting message if the text type call reception rejecting message is inputted; and
transmitting the converted call reception rejecting message to a caller using the caller identification.

12. The method of claim 11, wherein the text type call reception rejecting message is inputted by a key manipulation or is selected from among stored messages in the mobile communication terminal.

13. A mobile communication terminal comprising:
a call reception rejecting key for initiating a call reception rejecting function; and
a controller for identifying a caller identification included in an incoming call and transmitting a call reception rejecting message to a caller using the identified caller identification.

14. The mobile communication terminal of claim 13, wherein the call reception rejecting message is inputted by a key manipulation or is selected from among stored messages in the mobile communication terminal.

15. The mobile communication terminal of claim 13, wherein the call reception rejecting message is one of a short message service message, an email, a multimedia message system message and an enhanced message service message.

16. A mobile communication terminal comprising:
a call reception rejecting key for initiating a call reception rejecting function; and
a controller for identifying a caller identification included in an incoming call, and for controlling input of a text version call reception rejecting message and transmitting the converted call reception rejecting message to a caller using the identified caller identification.

17. The mobile communication terminal of claim 16, wherein the call reception rejecting message is inputted by a key manipulation or is selected from among stored messages in the mobile communication terminal.

18. The mobile communication terminal of claim 16, wherein the call reception rejecting message is one of a short message service message, an email, a multimedia message system message or an enhanced message service message.

19. A mobile communication terminal comprising:
a call reception rejecting key for initiating a call reception rejecting function; and
a controller for identifying a caller identification included in an incoming call and transmitting an auto-answering message to a caller terminal if the caller identification is not identified.
